(19) United States
(12) Patent Application Publication
(10) Pub. No.: US 2003/0227364 A1
(43) Pub. Date: Dec. 11, 2003

(54) Power transforming apparatus with multiple parallel-connected transformers

(75) Inventors: Qiong Li, Cortlandt Manor, NY (US); Demetri Giannopoulos, Norwalk, CT (US); Yushan Li, Longmont, CO (US)

Correspondence Address: PHILIPS INTELLECTUAL PROPERTY & STANDARDS, P.O. BOX 3001, BRIARCLIFF MANOR, NY, 10510, US

(73) Assignee: Koniklijke Philips Electronics N.V.

(21) Appl. No.: 10/167,183

(22) Filed: Jun. 11, 2002

(51) Int. Cl. H01F 27/28

(52) U.S. Cl. 336/182

(57) ABSTRACT

A power transforming apparatus comprises at least two transformers connected parallel to each other between a common power source and a common output, each of said transformers including a primary and a secondary for transforming power from said same power source to said same output. The resistive loss is substantially decreased because the current is split among multiple transformers, and therefore the temperature of the transformer is kept low as less heat is produced from the transformer loss.

### FIELD OF THE INVENTION

The present invention relates to power transformers, and more particularly, to power transforming apparatus used in a contactless battery charger of a portable electronic device.

### BACKGROUND AND SUMMARY OF THE INVENTION

A battery charger is commonly used for rechargeable batteries in consumer electronics, such as cell phones, laptops, PDAs, etc. As shown in FIG. 1, conventionally a battery charger 2 for charging the battery 3 used in portable electronic devices 1 requires a connector 4 having a galvanic connection (metal contact) to an external power supply (e.g., a wall power socket). The battery charger 2 is usually embedded within the portable electronic device 1. A dc/dc type voltage regulator such as a buck converter is used as the charger circuit. It is well known that a bad contact at the galvanic connection is one of the most frequent failures.

To eliminate the cost of the connector and associated reliability problems, a battery charger without requiring a connector is used, which is shown in FIG. 2. The battery charger 1 consists of an external primary part 5 and an internal secondary part 6 to transform power from a power supply to a rechargeable battery 3 inside the device 1. The power is transformed from the primary part 5, which is connected to the power supply and is external to the portable device 1, to the secondary part 6 which is embedded in the portable device 1. In this contactless charging scheme, no metal contact is needed between the external primary part 5 and the internal secondary part 6, thus eliminating the potential bad contact problems.

This contactless charging scheme can be implemented, for example, by a single coreless PCB (printed circuit board) spiral transformer. FIG. 3 shows an exemplary circuitry of such a coreless PCB spiral transformer. In this example, an LC resonant converter is used to transfer the energy from the external primary part 5 to the internal secondary part 6 embedded in the portable device. LLC resonant circuit or other variant resonant and soft switching circuits can also be used instead of the LC resonant converter. Such a coreless or air core PCB spiral transformer has a low profile, a miniaturized implementation as well as a low cost.

However, the transformer losses in the circuit implementations with such a single transformer limits the power delivered to the battery. The transformer loss is significantly increased when the output power increases due to the high resistance in the spiral transformer. At the same time, the temperature of the coil in the transformer is substantially increased because of the heat produced from the transformer loss, which may be too high for any practical application.

Therefore, there exists a need for an improved power transforming scheme applicable in a contactless battery charger that has a higher efficiency and thus a lower transformer loss and a lower coil temperature.

According to the invention, a power transforming device is disclosed which comprises at least two transformers connected parallel to each other between a common power source and a common output, and each of the transformers comprises a primary and a secondary for transforming power from the same power source to the same output.

With such a novel scheme, the current is split in the multiple transformers, which substantially decreases the resistive losses in both primaries and secondaries circuits since the resistive loss is proportional to the square of the current. With the resistive loss decreased, the coil temperature is also kept low as the output power increases, since there is less heat produced from the transformer loss.

In an embodiment, the secondaries are in phase to each other and share a bridge rectifier. In a preferred embodiment, the secondaries are 180° out of phase to each other, and each is connected to the output or load via a single rectifier diode, thus further decreasing the loss by using fewer diodes. In a further preferred embodiments, the primary and secondary in a transformer are 180° out of phase, thus the total current of the transformer is reduced because the magnetizing current is opposite to the current to the secondary. This further decreases loss in the circuit because the primary current has a smaller rms value.

The transformers used in the present invention are preferably coreless PCB spiral transformers, which are small in size and low in cost.

### BRIEF DESCRIPTION OF THE DRAWINGS

The above and further features and advantages of the present invention will be readily understood from the following detailed description of the preferred embodiments with reference to the accompanying drawings, in which:

FIG. 1 schematically shows a prior art battery charger used in a portable electronic device, which requires a metal contact;

FIG. 2 schematically shows another prior art battery charger used in a portable electronic device, which incorporates a batter charger having an external primary part and an internal secondary part;

FIG. 3 illustrates a prior art coreless transformer circuitry used to implement power transform in the battery charger shown in FIG. 2;

FIG. 4 illustrates a circuitry of a first embodiment of the power transforming apparatus according to the present invention;

FIG. 5a illustrates a circuitry of a second embodiment of the power transforming apparatus according to the present invention;

FIG. 5b is a diagram showing the circuit waveforms of the second embodiment shown in FIG. 5a;

FIG. 6a illustrates a circuitry of a third embodiment of the power transforming apparatus according to the present invention; and

FIG. 6b is a diagram showing the circuit waveforms of the third embodiment shown in FIG. 6a.

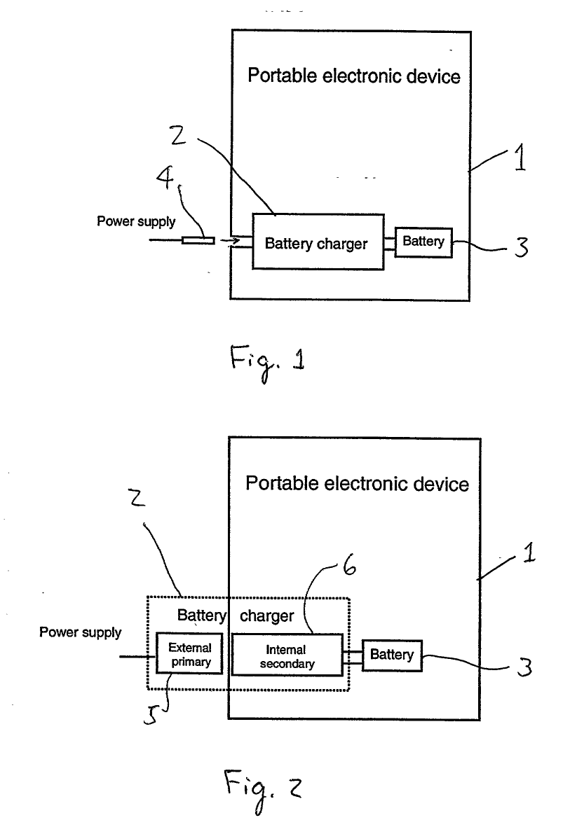

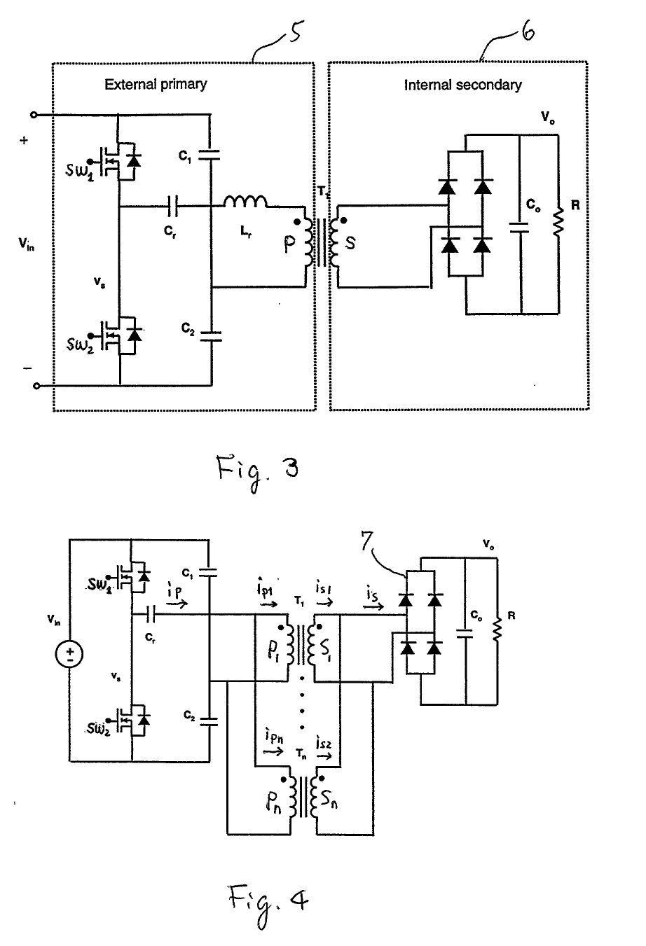

### DETAILED DESCRIPTION OF THE PREFERRED EMBODIMENT

Reference is now made to FIG. 4 which illustrates the circuitry of first embodiment of the power transforming apparatus of the present invention. Similar reference numbers are used throughout the figures in the drawings to indicate similar elements.

As shown in FIG. 4, the power transforming apparatus in the present invention comprises multiple identical transformers T₁, T₂, . . . , Tₙ, arranged in parallel to each other between the power source and the output. In particular, in the primary part, each of the primaries P₁, P₂, . . . , Pₙ of each transformer T₁, T₂, . . . , Tₙ is equally connected to the same power source Vᵢₙ via a soft switching circuit consisting of transistors SW₁, SW₂ and capacitors C₁, C₂ and Cᵣ. In the secondary part, each of the corresponding secondaries S₁, S₂, . . . , Sₙ is equally connected to the output or load R via a bridge rectifier 7 consisting of four rectifier diodes.

Assuming all the transformers are identical, the total current is split in each transformer to 1/n of the total current, thus the resistive loss in each transformer is reduced to (1/n)² of that if only a single transformer is used, because the resistive loss in a transformer is in proportion to the square of the current in the transformer. The splitting of the current applies in both the primary part and the secondary part. In particular, in the primary part, the total current iₚ is split in currents iₚ₁, iₚ₂, . . . , iₚₙ in each of the transformers T₁, T₂, . . . , Tₙ, while in the secondary part, the total current iₛ is split in currents iₛ₁, iₛ₂, . . . , iₛₙ in each of the transformers.

Therefore, the total losses in all n transformers for the same load is reduced to 1/n of the original losses using a single transformer (assuming that the magnetizing current is much smaller than the load current). Thus, more power can be delivered to the load since less heat will be produced from the transformer loss which may otherwise increase the coil temperature beyond acceptable.

It is noted that the primary and secondary in each transformer is in phase to each other. However, they can be 180° out of phase instead, if desired.

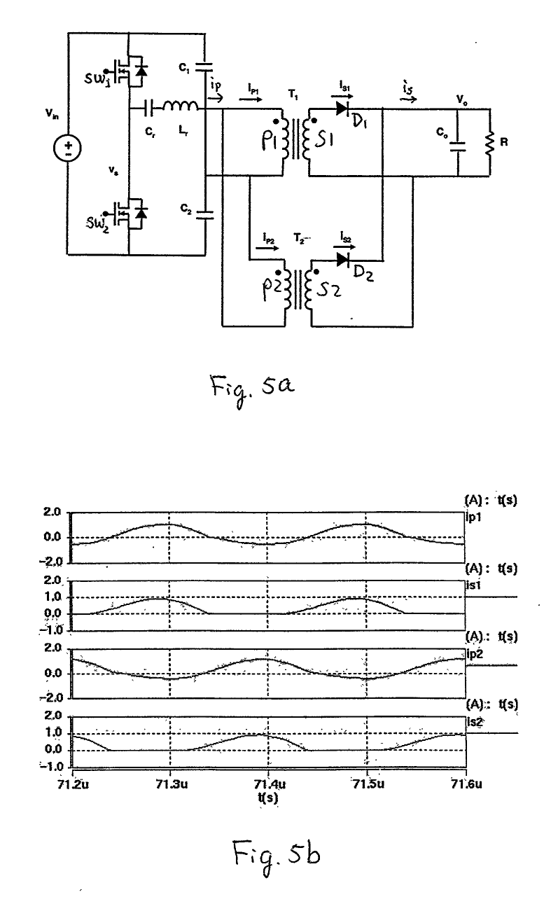

FIG. 5a illustrates a second embodiment of the power transforming apparatus of the present invention. In this embodiment, two identical transformers T₁ and T₂ are used for transforming power from the same power source Vᵢₙ to the same output or load R. In particular, each of the transformers T₁ and T₂ is equally connected to the same power source Vᵢₙ via a CL resonant converter circuit consisting of Cᵣ and Lᵣ.

The primary and secondary in each transformer T₁, T₂ is shown in phase, while the secondaries S₁ and S₂ are 180° out of phase to each other because the currents ip1 and ip2 in the two transformers T1 and T2 are 180° out of phase in the circuitry topology in FIG. 5a. Therefore, the bridge rectifier 7 in the first embodiment shown in FIG. 4 can be omitted and replaced by single rectifier diode D₁, D₂ between each transformer T₁, T₂ and the output. Thus, the transformer loss of the circuit is further decreased in this embodiment as less diodes are used. The current waveforms for the embodiment in FIG. 5a is shown in FIG. 5b illustrating the current in each transformer T₁, T₂.

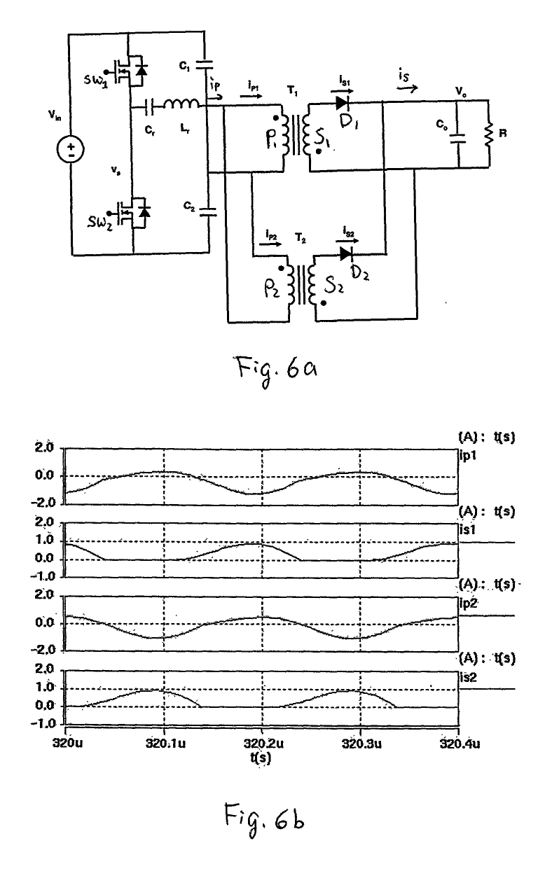

FIG. 6a illustrates a third embodiment of the power transforming apparatus of the present invention. This embodiment is similar to that in FIG. 5a, except that the primary P₁, P₂ and its corresponding secondary S₁, S₂ in each transformer T₁, T₂ are 180°° out of phase. In this embodiment, the power is stored in each primary P₁, P₂ when the primary current in each transformer T₁, T₂ is positive, and transferred to the secondary S₁, S₂ when the primary P₁, P₂ has negative currents. Thus, from its waveforms shown in FIG. 6b, it can be noted that the primary current of each transformer T₁, T₂ has a smaller peak value comparing with that of the second embodiment shown in FIG. 5b. So the loss can be further reduced.

Though only two transformers T₁, T₂ are shown in the embodiments in FIGS. 5a and 5b, it is appreciated that more than two transformers can be used to further split the current.

The preferred embodiments have been described in detail in the above for only exemplary purpose. It shall be appreciated that, without departing the spirit of the invention, numerous changes, adaptations and variations are obvious to those skilled in the art. For example, though the invention is disclosed with the application as a battery charger for portable electronic devices, it can be applicable to any device or unit that requires a power transform. The transformers used here are not necessarily limited to the coreless PCB spiral transformers, and can be other types of power transformers. The transformers may not be identical as long as a desired output can be reached via a proper rectifying circuitry. In addition to the LC resonant circuit shown in the embodiments, LLC and other variant resonant and soft switching circuits can also be used. Therefore, the scope of the invention is intended to be solely defined in the accompanying claims.

What is claimed is:

1. A power transforming and charging apparatus comprising at least two transformers connected parallel to each other between a common power source and a common output, each of said transformers comprising a primary and a secondary for transforming power from said same power source to said same output said output being arranged to charge a portable device.

2. The apparatus of claim 1 wherein said secondaries of said at least two transformers are in phase with each other.

3. The apparatus of claim 2 wherein said secondaries are connected to said output through a bridge rectifier.

4. The apparatus of claim 1 wherein said secondaries of said at least two transformers are 180° out of phase to each other.

5. The apparatus of claim 4 wherein each of said secondaries is connected to said output through a single rectifier diode.

6. The apparatus of claim 4 wherein in each of said transformers, said primary and said secondary is in phase.

7. The apparatus of claim 4 wherein in each of said transformers, said primary and said secondary is 180° out of phase.

8. The apparatus of claim 1 wherein said primaries are connected to said power source through an LC resonant converter.

9. The apparatus of claim 1 wherein said primaries are connected to said power source through an LLC resonant converter.

10. The apparatus of claim 1 wherein each of said transformers is a coreless transformer.

11. The apparatus of claim 1 wherein each of said transformers is a coreless PCB spiral transformer.

12. The apparatus of claim 1 wherein said transformers are identical to each other.

13. A battery charger comprising a power transforming circuitry for transforming power from a power source to A battery, wherein said power transforming circuitry comprises at least two transformers connected parallel to each other between said same power source and said same battery, each comprising a primary and a secondary for transforming power from said power source to said battery.

14. The battery charger of claim 13 wherein each of said transformers is a coreless PCB spiral transformer.

15. The battery charger of claim 13 wherein said transformers are identical to each other.

16. The battery charger of claim 13 wherein said secondaries in said at least two transformers are in phase to each other, and are connected to said battery through a bridge rectifier.

17. The battery charger of claim 13 wherein said secondaries in said at least two transformers are 180° out of phase to each other, each being connected to said battery through a single rectifier diode.

18. An electronic device comprising a battery charger for charging a battery internally accommodated in said electronic device, wherein said battery charger comprises a power transforming circuitry having at least two transformers connected parallel to each other between a common power source and said same battery, each transformer comprising a primary and a secondary for transforming power from said same power source to said battery.

19. The electronic device of claim 18 wherein said primary is located external to said electronic device, while said secondary is located internal to said electronic device.

20. The electronic device of claim 18 wherein said transformers are coreless PCB spiral transformers.
